(19) United States
(12) Patent Application Publication
(10) Pub. No.: US 2022/0315138 A1
(43) Pub. Date: Oct. 6, 2022

(54) TRACK ASSEMBLY FOR HOBBY ROBOTICS

(71) Applicant: Robotzone, LLC, Winfield, KS (US)

(72) Inventors: Brian T. Pettey, Winfield, KS (US); Lucas Allen Smith, Winfield, KS (US)

(21) Appl. No.: 17/706,979

(22) Filed: Mar. 29, 2022

Related U.S. Application Data
(60) Provisional application No. 63/170,167, filed on Apr. 2, 2021.

(51) Int. Cl. B62D 55/21; B62D 55/20

(52) U.S. Cl. CPC B62D 55/21; B62D 55/202; B62D 55/125

(57) ABSTRACT

A track system for hobby robotics is provided. The track system includes a first track component having a pair of lateral edges and a connection portion disposed at each lateral edge. The track system also includes a second track component having a pair of lateral edges and a connection portion disposed at each lateral edge. The first track component is hingedly coupled to the second track component at a respective connection portion of each of the first and second track components. An individual track component is also provided.

### CROSS-REFERENCE TO RELATED APPLICATIONS

The present application is based on and claims the benefit of U.S. Provisional Patent Application Ser. No. 63/170,167, filed Apr. 2, 2021, the content of which is hereby incorporated by reference in its entirety.

### BACKGROUND

Hobby robotic systems often include a variety of structural and motion components coupled to one another. In the field of hobby robotics, it is common to assemble various structural and motion components to create robotic systems. In such systems, motion components include often include wheels or some other suitable mechanism to drive a machine.

### SUMMARY

A track system for hobby robotics is provided. The track system includes a first track component having a pair of lateral edges and a connection portion disposed at each lateral edge. The track system also includes a second track component having a pair of lateral edges and a connection portion disposed at each lateral edge. The first track component is hingedly coupled to the second track component at a respective connection portion of each of the first and second track components. An individual track component is also provided.

### BRIEF DESCRIPTION OF THE DRAWINGS

FIGS. 1 and 2 are perspective views showing a topside and an underside, respectively, of an example track assembly.

FIG. 3 is a side view showing an example track assembly.

FIG. 4 is a front view showing an example track assembly.

FIG. 5 is a rear view showing an example track assembly.

FIG. 6A is a perspective view showing an example track assembly.

FIG. 6B is a sectional view showing an example track assembly.

FIG. 7 is a top view showing an example track component.

FIG. 8 is a bottom view showing an example track component.

FIG. 9 is a front view showing an example track component.

FIG. 10 is a rear view showing an example track component.

FIG. 11 is a front view showing an example traction component.

FIG. 12 is a perspective view showing an example traction component.

FIG. 13 is a rear view showing an example track assembly.

FIG. 14 is a perspective view showing an example track assembly.

FIG. 15 is a perspective view showing an example partial exploded track assembly.

FIG. 16 is a perspective view showing an example track assembly.

FIG. 17 is a perspective view showing an example track assembly.

FIG. 18 is a perspective view showing multiple example track assemblies.

### DETAILED DESCRIPTION OF ILLUSTRATIVE EMBODIMENTS

In some hobby robotics systems, tracks are used to drive the machine. Often the track systems are non-modular and can only be added to a system in a pre-defined way. Thus, if the hobby robotic system needs to be modified for a particular purpose, it may not be possible to use the non-modular track system.

In accordance with various embodiments described below, example track assemblies have several features that make them more easily integrated into a modular robotics kit. In one example, the tracks can have a 24 mm pitch (meaning the distance from one track to the next is 24 mm) so that they properly align with a modular structure component such as that sold under the trade designation, 1120 Series U-Channel, available from Gobilda.com. The length of an assembly of tracks can easily be adjusted to match the length of the chassis. The tracks preferably link to one another using standard threaded fasteners, such as M4 bolts and nuts. The bores through which the M4 bolts pass are sized to allow the M4 bolt to slip through. In one embodiment, the bore is approximately 5 mm in diameter. Using standard hardware makes re-configuring (adding and removing individual tracks) very quick and easy. The long bolt through each track link can also add a considerable amount of strength throughout. A round protrusion on each side of a track link can be used as a drive mechanism. Having sprockets drive the tracks from the outer edge adds lateral support to the tracks. Inner cavities of the tracks can be used as an alternate drive mechanism. Doing so keeps the drive mechanism concealed while supporting the center of the tracks. Flat areas on the underside of the tracks allow idler wheels to be placed along the track assembly without interfering with the drive mechanism. Protrusions on the underside of the tracks can be spaced apart (preferably by 48 mm) so that parts that lap over the edge of an 1120 Series U-Channel will create a guide for the tracks to center on. At least two embodiments are provided: 1) tracks with bonded rubber tread and 2) tracks without bonded rubber tread. The absence of rubber tread exposes holes that are 4 mm in diameter and spaced 8 mm apart in order to align on an 8 mm grid pattern. Due to the 24 mm pitch of the track, the holes also align with an 8 mm grid from one track to the next. Having holes on grid allow nearly any modular kit component to attach to a track.

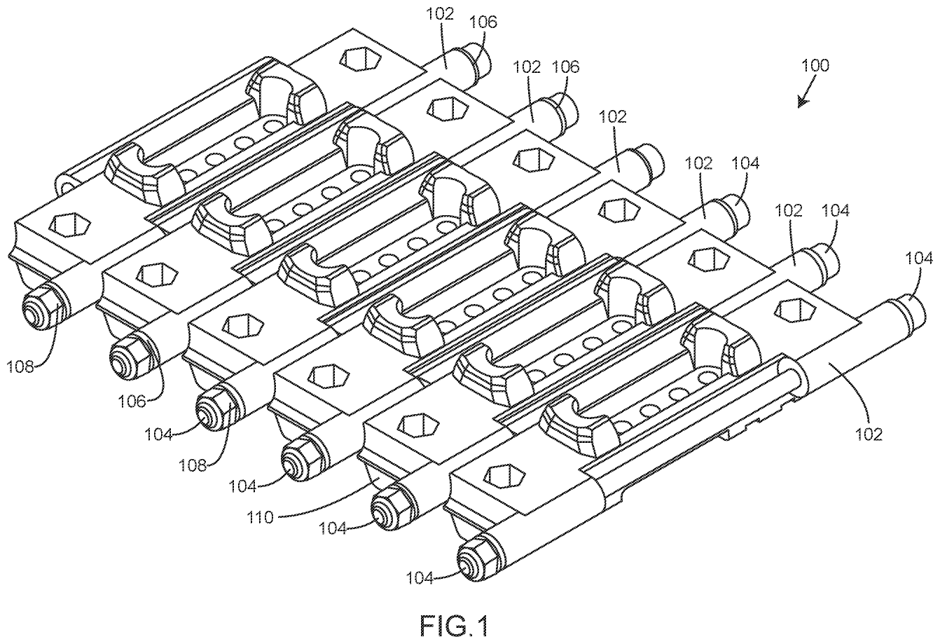

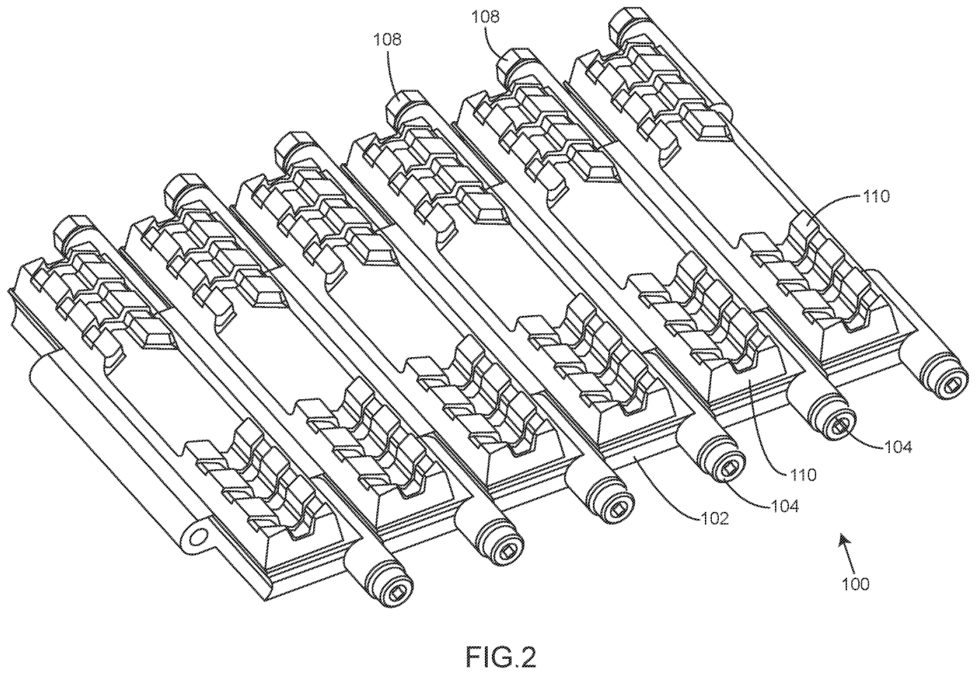

FIGS. 1 and 2 are perspective views showing a topside and an underside, respectively, of an example track assembly. Track assembly 100 includes track components 102, fasteners 104, washers 106, nuts 108, and traction components 110. Track components can be constructed from any suitable material. In one embodiment, track components 102 are constructed from plastic. In embodiments where track component is constructed from plastic, any suitable manufacturing process such as casting, extruding, injection molding, 3D printing can be used. Track components 102 couple to one another via fasteners 104. Fasteners 104 are kept on track components 102 by nuts 108. Washers 106 can be disposed between fastener 104 and track component 102 and between nut 108 and track component 102. As shown, fastener 104 is a long socket head bolt with a short, threaded portion on the end. However, it is expressly contemplated that the threaded portion may extend from the head of the fastener to the end of the fastener. Further, it is also expressly contemplated that fastened 104 could simply be a length of threaded rod with nuts engaged on both ends. In other examples, fastener 104 could include other features or be a different type of fastener. Fasteners 104 are inserted through at least one aperture of a first track component 102 and into at least one aperture of a second track component 102.

Provided on the ground engaging side of the track components 102 can be traction components 110. Traction components 110 can protect track components 102 from wear by the ground. Traction components 110 can include material that increases the traction between the track assembly 100 and the ground. Traction components 110 can be constructed from any suitable material but are preferably constructed from rubber or plastic. In the illustrated embodiment, each traction component includes a raised chevron shape that points toward an outer edge of the track component 102. However, those skilled in the art will recognize that changes can be made to the configuration of traction component 110 to have different shapes, sizes, and arrangements, as desired.

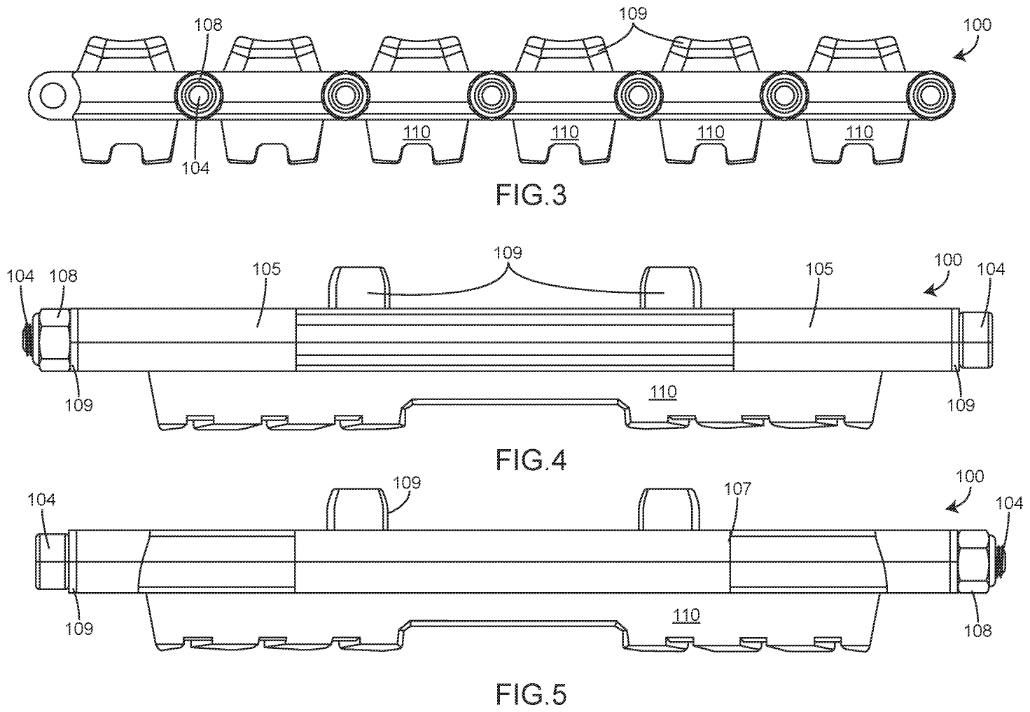

FIG. 3 is a side view showing an example track assembly. In this view, a shape of traction component 110 can be seen. The exterior of traction component 110 is tapered such that, when track components 102 are rotated about fasteners 104, traction components 110 do not impede the movement of track components 102. This is useful as track assembly 100 is formed into a continuous track about two wheels. Similarly, features 109 also can be seen as being tapered for similar reasons. Features 109 can engage other components to drive movement of track components 102.

FIG. 4 is a front view showing an example track assembly and FIG. 5 is a rear view showing an example track assembly. In this view, treads of traction component 110 can be seen. A width between features 109 also can be seen. This width can be used to align track components 102 onto another component. Features 109 can also engage guide wheels or driving components that guide and/or drive track components 102.

Connection portion 107 of a track component 102 is configured to fit between connection portions 105 of another track component 102 such that bores of connection portions 107, 105 align to receive a fastener 104. Fastener 104 is fit through bores of these connection portions 105 and 107 to couple the separate track components 102 together. In some examples, there are more than three connection portions 105/107. In some examples, there are less than three connection portions 105/107.

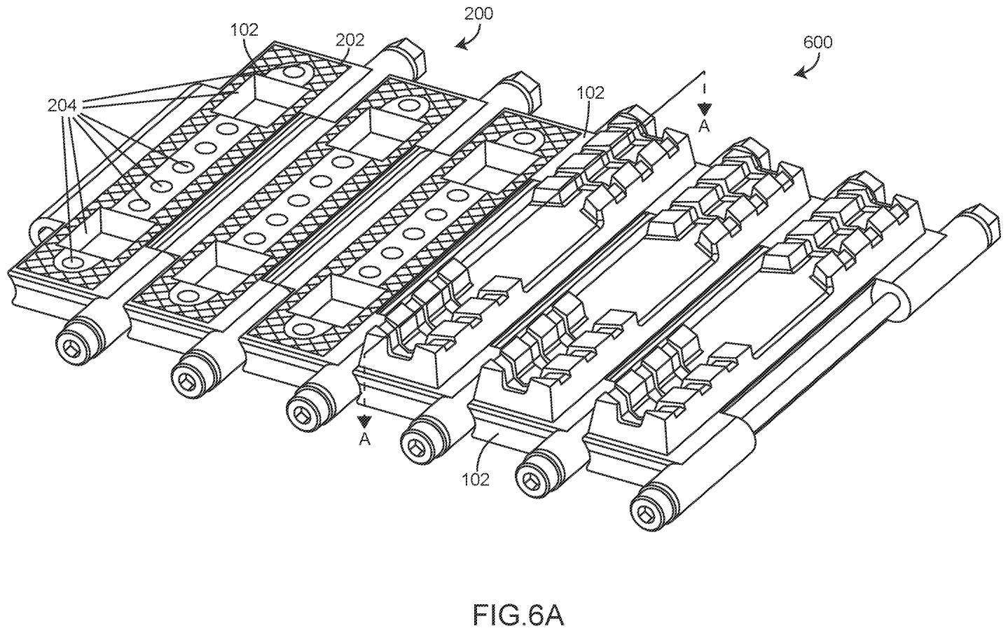

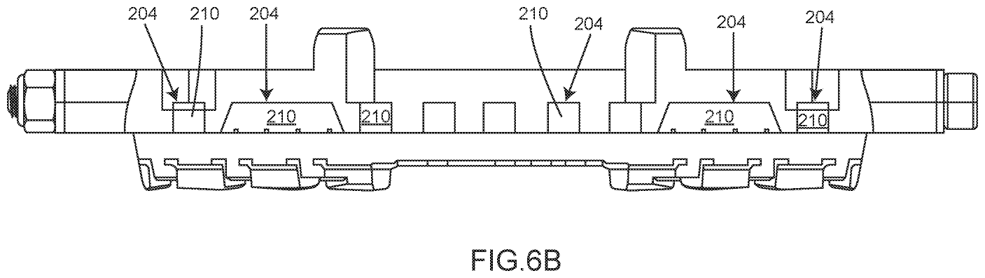

FIG. 6A is a perspective view showing an example track assembly. FIG. 6A shows a portion of track assembly 600 with traction components 110 and a portion of track assembly 200 without traction components 110. As can be seen, there can be traction features 202 on the ground-engaging surface of track components 102. There can also be coupling features 204 on the ground-engaging surface. Coupling features 204 are used to couple components to track components 102. For example, coupling features 204 are used to couple traction component 110 to track component 102. When a traction component 110 is coupled to track component 102, traction features 102 are covered by the traction component 110.

FIG. 6B is a sectional view showing an example track assembly. The sectional view is taken along the plane A-A shown in FIG. 6A. As can be seen, coupling features 204 of track component 102 receive coupling features 210 (shown as cylinders) of traction component 110. In some examples, coupling features 204, 210 friction fit together. In other examples, coupling features 204, 210 are held together in other ways. For example, coupling features 204, 210 can snap fit together. Or, for example, fasteners can be used to couple traction component 110 to track component 102.

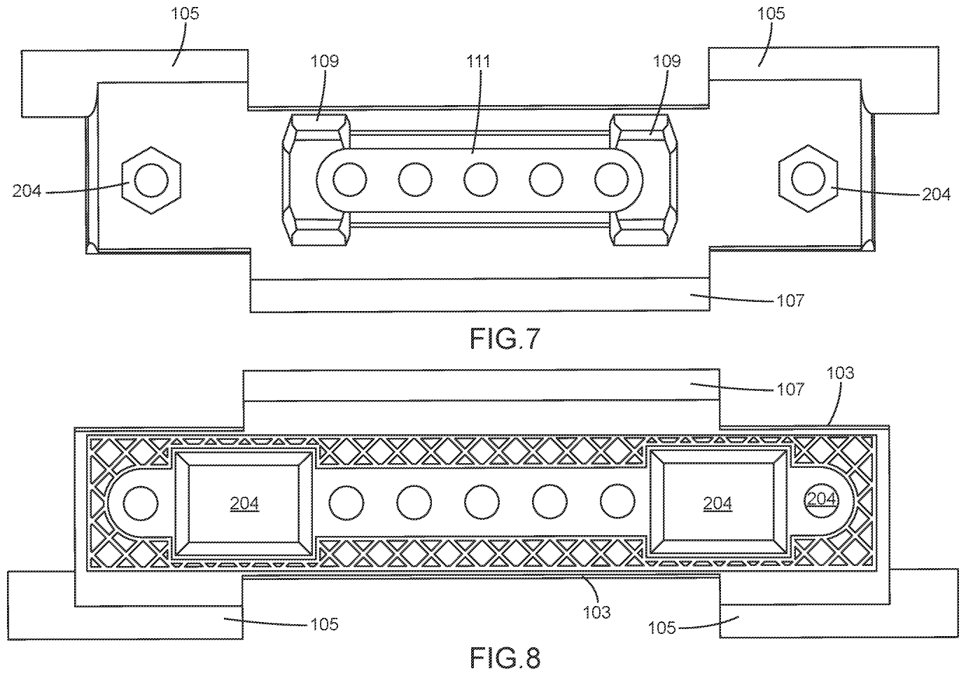

FIG. 7 is a top view showing an example track component. In this view, the relative locations of connection portions 105/107, features 109, and coupling features 204 are visible. In some examples, there may be more or fewer coupling features 204. In some examples, there may be more or fewer features 109. In some examples, there may be more or fewer connection portions 105/107. Portion 111 can be configured to mate with a drive component that drives movement of one or more track components 102.

FIG. 8 is a bottom view showing an example track component. In this view, the relative locations of connection portions 105/107, and coupling features 204 are visible. As can be seen, track component 102 includes a pair of lateral edges 103 with a connection portion disposed at least lateral edge 103.

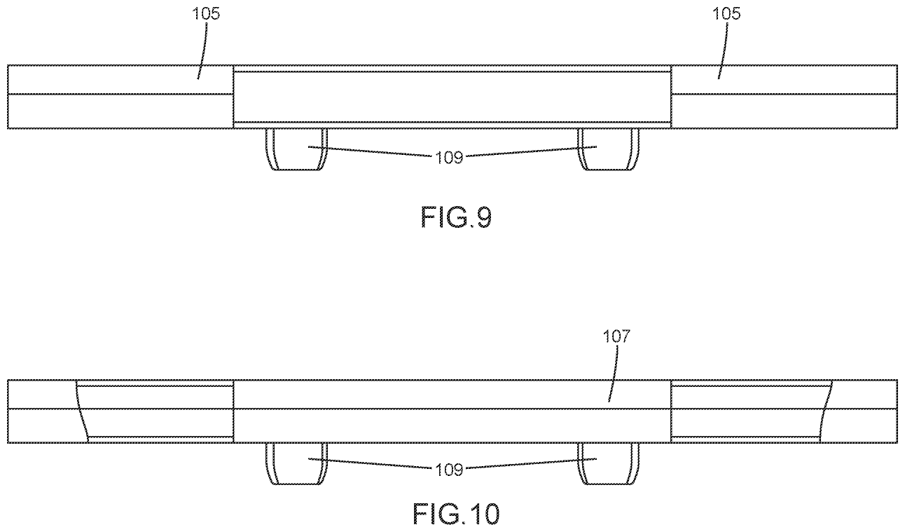

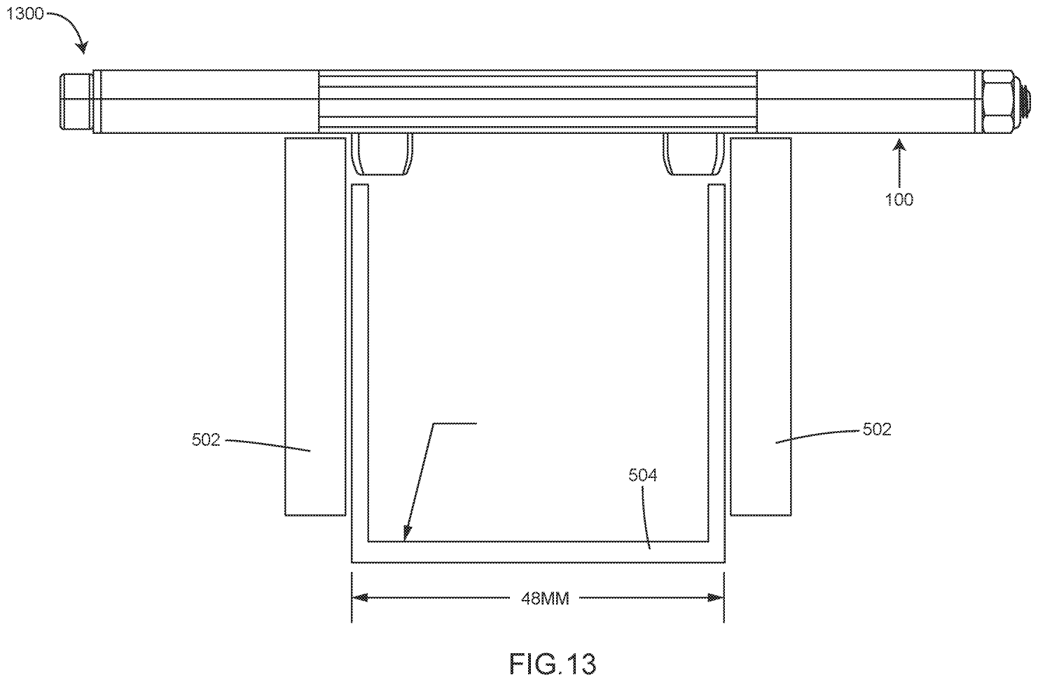

FIG. 9 is a front view showing an example track component. FIG. 10 is a rear view showing an example track component. In these views, a width between features 109 can be seen. This width can be used to align track components 102 onto another component. Some examples of alignment with another component are shown in FIGS. 13-18. Features 109 can also engage guide wheels or driving components that guide and/or drive track components 102. Either side of features 109 is flat such that a wheel can smoothly roll along this surface.

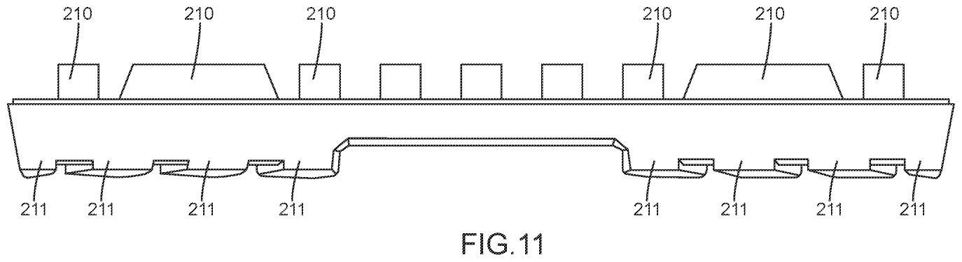

FIG. 11 is a front view showing an example traction component 110.

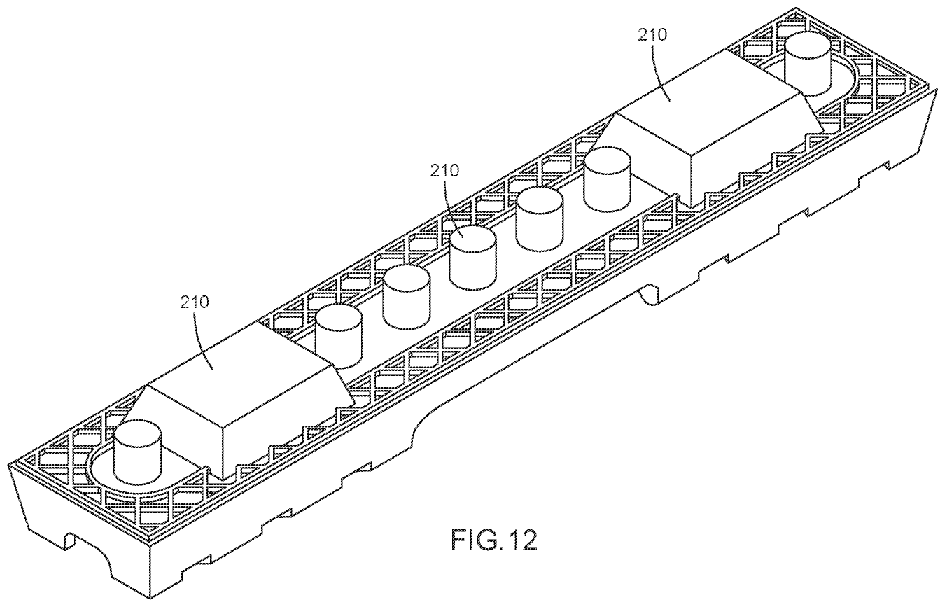

FIG. 12 is a perspective view showing an example traction component. Traction component 110 includes coupling features 210 and treads 211. In some examples, there are more or fewer coupling features 210. In some examples, there are more or fewer treads 211.

FIG. 13 is a rear view showing an example track assembly 1300. Assembly 100 includes track assembly 100, wheels 502 and channel 504. As shown, wheels 502 are rotatably coupled to channel 504. While wheel 502 are shown, embodiments can be practiced where sliders are used in place of some or all wheels 502. In the illustrated example, channel 504 has a width of about 48 mm. Track assembly 100 rides along wheels 502, which allow track assembly 100 to operate in a continuous track about the top of channel 504. In the shown alignment, track assembly 100 does not contact channel 504. The width of channel 504 corresponds to the width of features 109, such that wheels 502 align with features 109. This alignment prevents track assembly 100 from laterally falling off channel 504.

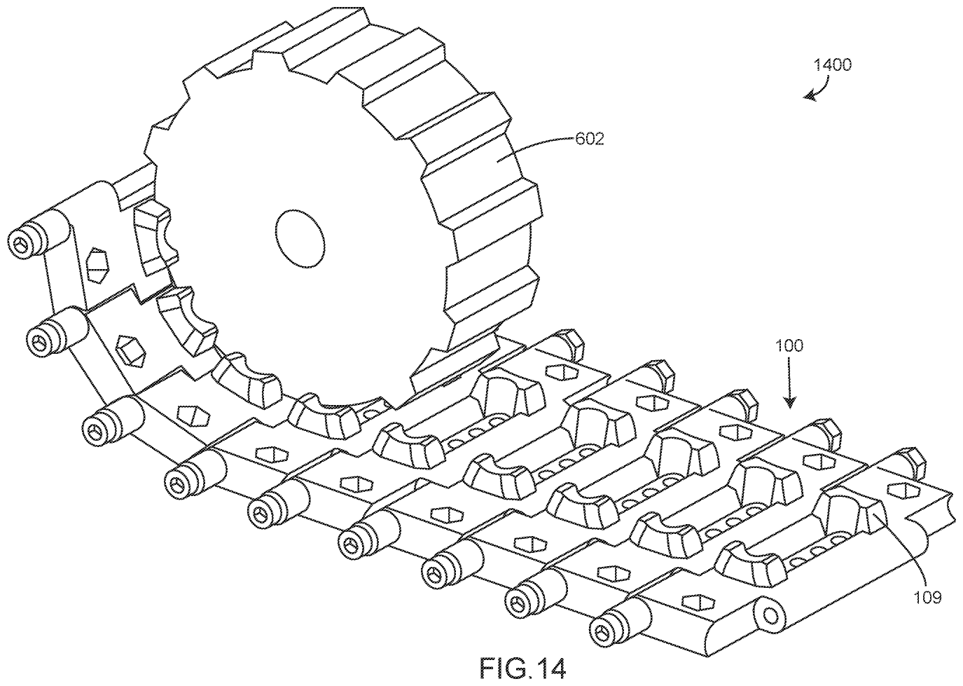

FIG. 14 is a perspective view showing an example track assembly 1400. Assembly 1400 includes a track assembly 100 and a track drive 602. Track drive 602 engages portions 109 of track assembly 100. As track drive 602 rotates, track assembly 100 is driven. In some examples, track drive 602 drives a continuous track assembly 100.

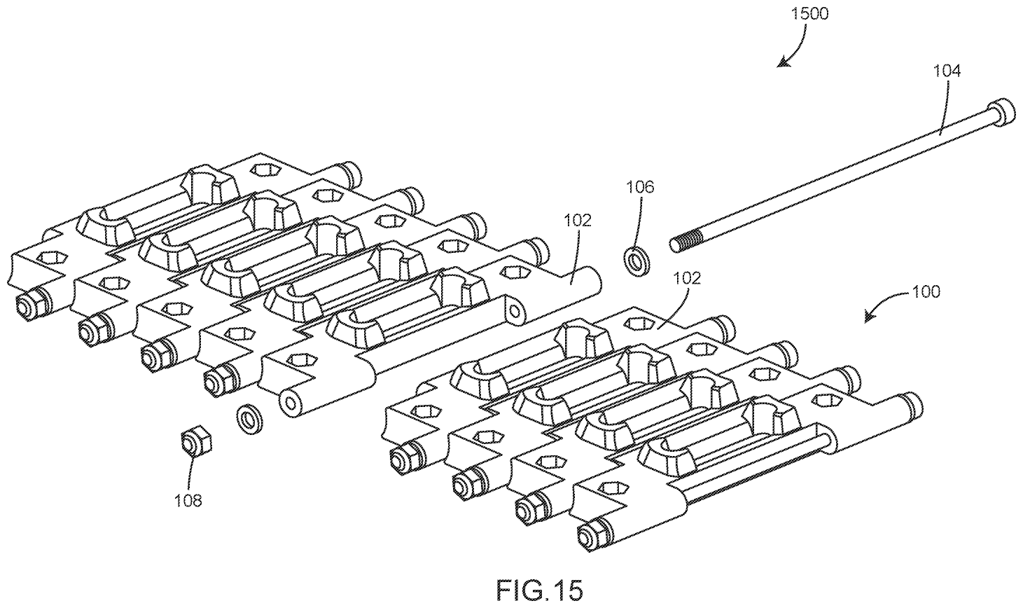

FIG. 15 is a perspective view showing an example partial exploded track assembly. In this view the entirety of fastener 104 is shown. As noted above, fastener 104 can include other features as well.

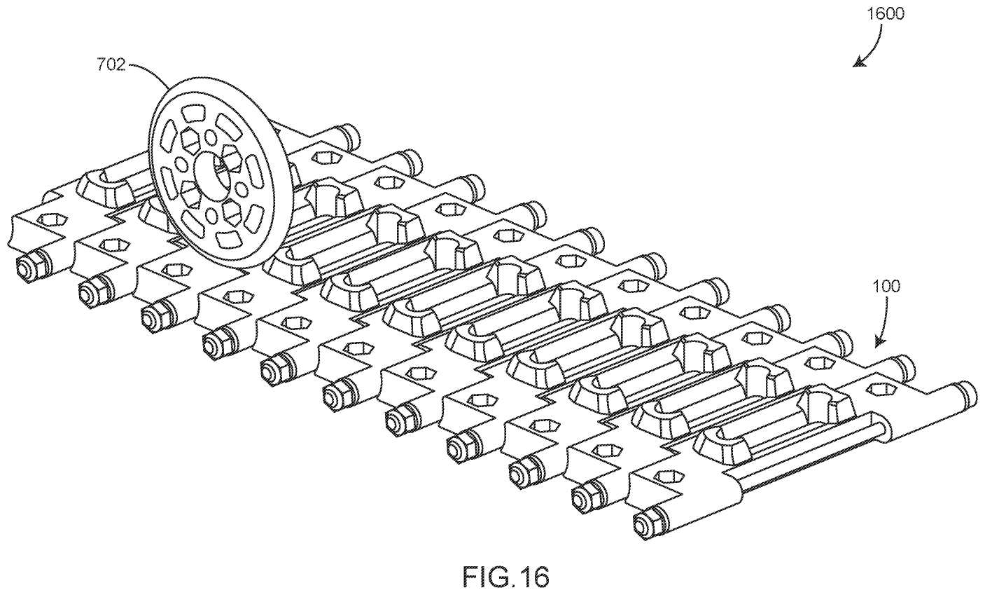

FIG. 16 is a perspective view showing an example track assembly 1600. Assembly 1600 includes track assembly 100 and idler 702. One or more idlers 702 can be provided along the length of a track to carry the track back off the ground and returns it to the drive (rear idler wheel) or receives track from the drive and lays it down in front (front idler wheel). In some examples, idler 702 can be used to support weight of a coupled vehicle (e.g., used as a technical ‘road wheel’).

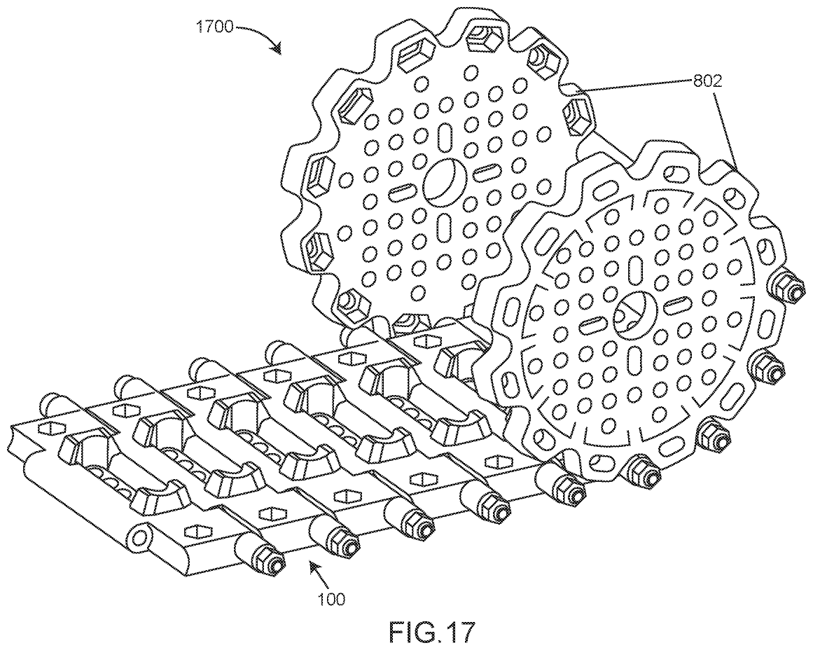

FIG. 17 is a perspective view showing an example track assembly 1700. Track assembly 1700 includes track assembly 100 and drives 802. When drives 802 rotate, they drive movement of track assembly 100. Drives 802 can be used in conjunction with, or as an alternate to drive 602. Of course, either of these drives 802, 602 can be used as idlers or road wheels as well.

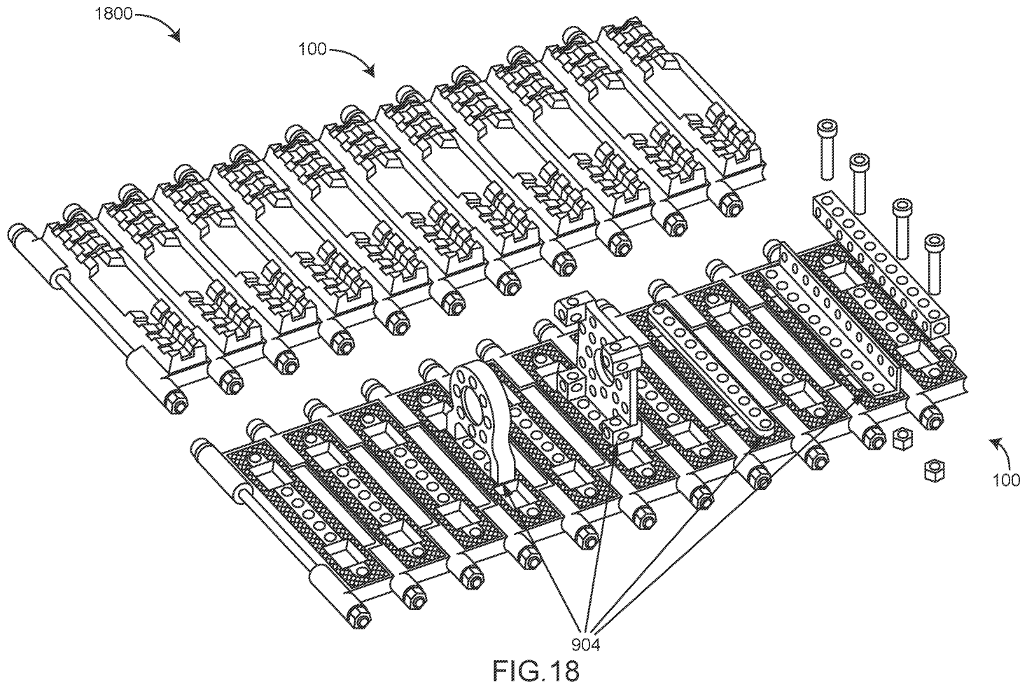

FIG. 18 is a perspective view showing multiple example track assemblies 1800. As shown, the track assemblies 100 couple to various components 904. Some of these components 904 shown include square beams, L-beams, flat beams, quad block pattern mounts, and 2 post pattern mounts. In other examples, other components can also couple to the track components 102. Some example other components include flat mounts, dual block mounts, surface mounts, U-channel, brackets, etc.

Although the present invention has been described with reference to preferred embodiments, workers skilled in the art will recognize that changes may be made in form and detail without departing from the spirit and scope of the invention.

What is claimed is:

1. A track system for hobby robotics comprising:
a first track component having a pair of lateral edges and a connection portion disposed at each lateral edge;
a second track component having a pair of lateral edges and a connection portion disposed at each lateral edge; and
wherein the first track component is hingedly coupled to the second track component at a respective connection portion of each of the first and second track components.

2. The track system of claim 1, wherein each connection portion includes a bore sized to pass a fastener therethrough.

3. The track system of claim 2, and further comprising a fastener extending through a bore of a connection portion of each the first and second track portions.

4. The track system of claim 3, and further comprising a first washer disposed between a head of the fastener and the connection portion.

5. The track system of claim 4, and further comprising a second washer disposed between a nut, engaged to the fastener, and the connection portion.

6. The track system of claim 1, and further comprising at least one additional track component coupled to at least one of the first and second track components.

7. The track system of claim 6, wherein a sufficient number of additional track components are coupled together to form a continuous track loop.

8. The track system of claim 6, and further comprising a drive wheel operably coupled to the track system to drive the track system.

9. The track system of claim 8, wherein the drive wheel is positioned in a central region of the track assembly.

10. The track system of claim 8, wherein the drive wheel is positioned proximate an edge of the track system.

11. A track component for hobby robotics, the track component comprising:
a first lateral edge and a first connection portion disposed proximate the first lateral edge;
a second lateral edge and a second connection portion disposed proximate the second lateral edge;
a ground-engaging surface having traction features disposed thereon and at least one coupling feature.

12. The track component of claim 11, wherein the first connection portion is configured to couple to a second connection portion of a second track component that is identical to the first track component.

13. The track component of claim 11, wherein each connection portion has a bore sized configured to receive a fastener.

14. The track component of claim 13, wherein each bore has a 5 mm diameter.

15. The track component of claim 11, and further comprising a traction component couple to the ground-engaging surface using the coupling feature of the ground-engaging feature.

16. The track component of claim 15, wherein the coupling feature of the ground-engaging feature includes at least one aperture and wherein the traction component includes at least one cylindrical portion configured to engage the at least one aperture of the coupling feature.

17. The track component of claim 15, wherein the traction component includes bonded rubber.

18. The track component of claim 15, wherein the traction component includes a plurality of raised chevrons.

19. The track component of claim 11, wherein the track component is constructed from plastic.

20. The track component of claim 11, wherein the track component includes a plurality of mounting holes arranged in a standard configuration to mount an additional component.
